(19) United States
(12) Patent Application Publication
(10) Pub. No.: US 2011/0212377 A1
(43) Pub. Date: Sep. 1, 2011

(54) FUEL CELL SYSTEM AND MOBILE ARTICLE

(75) Inventors: Norimasa ISHIKAWA, Toyota-shi (JP); Yoshiaki NAGANUMA, Nisshin-shi (JP); Yoshinobu HASUKA, Toyota-shi (JP)

(73) Assignee: TOYOTA JIDOSHA KABUSHIKI KAISHA, Toyota-shi (JP)

(21) Appl. No.: 13/088,082

(22) Filed: Apr. 15, 2011

Related U.S. Application Data
(62) Division of application No. 12/083,981, filed on Apr. 23, 2008.

(30) Foreign Application Priority Data
Dec. 15, 2005 (JP) 2005-362043

(51) Int. Cl. H01M 8/04

(52) U.S. Cl. 429/444

(57) ABSTRACT

There is disclosed a fuel cell system including a fuel cell, a fuel supply system to supply a fuel gas to the fuel cell, an injector which adjusts a gas state on an upstream side of the fuel supply system to supply the gas to a downstream side, and a control unit which drives and controls the injector in a predetermined drive cycle. The control unit sets the drive cycle of the injector in accordance with an operation state of the fuel cell.

This is a division of application Ser. No. 12/083,981 filed 23 Apr. 2008, which is a 371 national phase application of PCT/JP2006/324624 filed 5 Dec. 2006, which claims priority of Japanese Patent Application No. 2005-362043 filed 15 Dec. 2005, the contents of which are incorporated herein by reference.

### FIELD OF THE INVENTION

The present invention relates to a fuel cell system and a mobile article.

### BACKGROUND OF THE INVENTION

At present, a fuel cell system including a fuel cell which receives supply of a reactive gas (a fuel gas and an oxidizing gas) to generate a power has been suggested, and put to practical use. Such a fuel cell system is provided with a fuel supply channel for supplying, to the fuel cell, the fuel gas supplied from a fuel supply source such as a hydrogen tank.

In addition, when a supply pressure of the fuel gas from the fuel supply source is remarkably high, a pressure adjustment valve (a regulator) to reduce this supply pressure to a certain value is usually provided in a fuel supply channel. At present, a technology is suggested in which a mechanical type variable pressure adjustment valve (variable regulator) to change the supply pressure of the fuel gas in, for example, two stages is provided in the fuel supply channel, whereby the supply pressure of the fuel gas is changed in accordance with an operation state of the system (e.g., see Japanese Patent Application Laid-Open No. 2004-139984).

Moreover, in recent years, a technology has been suggested in which an injector is disposed in the fuel supply channel of the fuel cell system and an operation state of this injector is controlled, whereby the supply pressure of the fuel gas in the fuel supply channel is adjusted. The injector is an electromagnetic driving type opening/closing valve in which a valve body can directly be driven with an electromagnetic driving power in a predetermined drive cycle, and detached from a valve seat to adjust a gas state (a gas flow rate or a gas pressure). A control device drives the valve body of the injector to control an injection timing and an injection time of the fuel gas, whereby the flow rate and pressure of the fuel gas can be controlled. In the fuel cell system using such an injector, the control device drives the injector in a predetermined drive cycle. However, when the drive cycle is excessively long, pulsation might occur in the supply pressure of the fuel gas. Therefore, heretofore, the injector has been driven in a comparatively short constant drive cycle T shown in FIG. 8A, to suppress the pulsation of the supply pressure of the fuel gas.

### SUMMARY OF THE INVENTION

However, when an injector is driven in a comparatively short constant drive cycle, the following problem occurs. That is, to adjust a pressure of a fuel gas in accordance with an operation state of a fuel cell, a control device performs control so that an injection flow rate of the injector is reduced so as to reduce a supply pressure of the fuel gas in a case where a power generation current of the fuel cell is small. When the drive cycle of the injector is short and constant during such control, as shown in FIG. 8B, a non-injection time T₀ irregularly occurs, and the injector irregularly operates. When the injector irregularly operates in this manner, undesirable operation sound is generated.

The present invention has been developed in view of such a situation, and an object thereof is to suppress generation of undesirable operation sound in a fuel cell system including an injector.

To achieve the above object, a fuel cell system according to the present invention is a fuel cell system including a fuel cell, a fuel supply system to supply a fuel gas to this fuel cell, an injector which adjusts a gas state on an upstream side of this fuel supply system to supply the gas to a downstream side, and control means for driving and controlling this injector in a predetermined drive cycle, wherein the control means sets the drive cycle in accordance with an operation state of the fuel cell.

According to such a constitution, the drive cycle of the injector can be set (changed) in accordance with the operation state of the fuel cell (an amount of a power to be generated by the fuel cell (a power, a current, a voltage), a temperature of the fuel cell, an operation state during execution of a purge operation, an operation state during start, an intermittent operation state, an abnormal state of the fuel cell system, an abnormal state of a fuel cell main body, etc.). For example, in a case where a power generation current value of the fuel cell is small, the drive cycle can be lengthened, so that an irregular operation of the injector can be inhibited. As a result, generation of undesirable operation sound can be suppressed. It is to be noted that the “gas state” is a gas state indicated by a flow rate, pressure, temperature, molar concentration or the like, and especially includes at least one of the gas flow rate and the gas pressure.

In the fuel cell system, it is preferable that the control means sets the drive cycle to be long when an amount of a power generated by the fuel cell is small. Furthermore, in the fuel cell system, it is preferable that the control means sets the drive cycle to be long, when a pressure of the fuel gas supplied to the fuel cell is low.

In this case, the irregular operation of the injector during lowering of the amount of the power to be generated by the fuel cell and during lowering of the supply pressure of the fuel gas can be inhibited to suppress the generation of the undesirable operation sound.

Moreover, in the fuel cell system, the fuel supply system having a fuel supply channel to supply, to the fuel cell, the fuel gas supplied from the fuel supply system, a fuel discharge channel to discharge a fuel off gas coming from the fuel cell and a discharge valve to discharge the gas from the fuel discharge channel can be employed. In such a case, it is preferable that the control means controls an opening/closing operation of the discharge valve to execute a purge operation of the fuel off gas, and sets the drive cycle during the execution of the purge operation to a shorter time than during the execution of no purge operation.

In this case, the supply pressure of the fuel gas can be inhibited from temporarily lowering during the execution of the purge operation. As a result, lowering of a power generation performance during purge can be suppressed.

Moreover, in the fuel cell system, it is preferable that the control means performs calculation in a predetermined calculation period, and sets the drive cycle to a multiple number of the calculation period.

In this case, the drive cycle of the injector is easily synchronized with the calculation period of the control means, so that a control precision of the injector can be improved.

Furthermore, in the fuel cell system, it is preferable that the control means sets the drive cycle during totally opening control or totally closing control of the injector to a shorter time than during non-totally opening control or non-totally closing control.

In this case, it is possible to suppress overshoot (a state in which a control amount is above a target pressure value) of the injector during the totally opening control and undershoot (a state in which the control amount is below the target pressure value) of the injector during the totally closing control, whereby a control precision during the totally opening or totally closing control of the injector can be improved.

Moreover, a mobile article according to the present invention includes the fuel cell system.

Such a constitution includes the fuel cell system in which the irregular operation of the injector can be inhibited to suppress the generation of the undesirable operation sound, so that discomfort is scarcely given to a passenger of the mobile article. The operation sound is stabilized, whereby the passenger can be provided with feeling of security.

According to the present invention, in the fuel cell system including the injector, the generation of the undesirable operation sound can be suppressed.

### BRIEF DESCRIPTION OF THE DRAWINGS

FIG. 1 is a constitution diagram of a fuel cell system according to an embodiment of the present invention;

FIG. 2 is a control block diagram showing a control configuration of a control device of the fuel cell system shown in FIG. 1;

FIG. 3A is a map (a usual time: during the execution of no purge operation) indicating a relation between a power generation current value and a drive frequency of the fuel cell system shown in FIG. 1;

FIG. 3B is a map (during the execution of the purge operation) indicating a relation between the power generation current value and the drive frequency of the fuel cell system shown in FIG. 1;

FIG. 4A is a waveform diagram (a case where the power generation current value is large) indicating a waveform of the drive cycle of the injector of the fuel cell system shown in FIG. 1;

FIG. 4B is a waveform diagram (a case where the power generation current value is small) indicating a waveform of the drive cycle of the injector of the fuel cell system shown in FIG. 1;

FIG. 5 is a time chart showing history of a hydrogen gas supply pressure with time during totally opening control of the fuel cell system;

FIG. 6 is a flow chart showing an operation method of the fuel cell system shown in FIG. 1;

FIG. 7 is a constitution diagram showing a modification of the fuel cell system shown in FIG. 1;

FIG. 8A is a waveform diagram (a case where a power generation current value is large) indicating a waveform of a drive cycle of an injector of a conventional fuel cell system; and

FIG. 8B is a waveform diagram (a case where the power generation current value is small) indicating a waveform of the drive cycle of the injector of the conventional fuel cell system.

### DETAILED DESCRIPTION

A fuel cell system 1 according to an embodiment of the present invention will hereinafter be described with reference to the drawings. In the present embodiment, an example will be described in which the present invention is applied to a vehicle mounted power generation system of a fuel cell vehicle S (a mobile article).

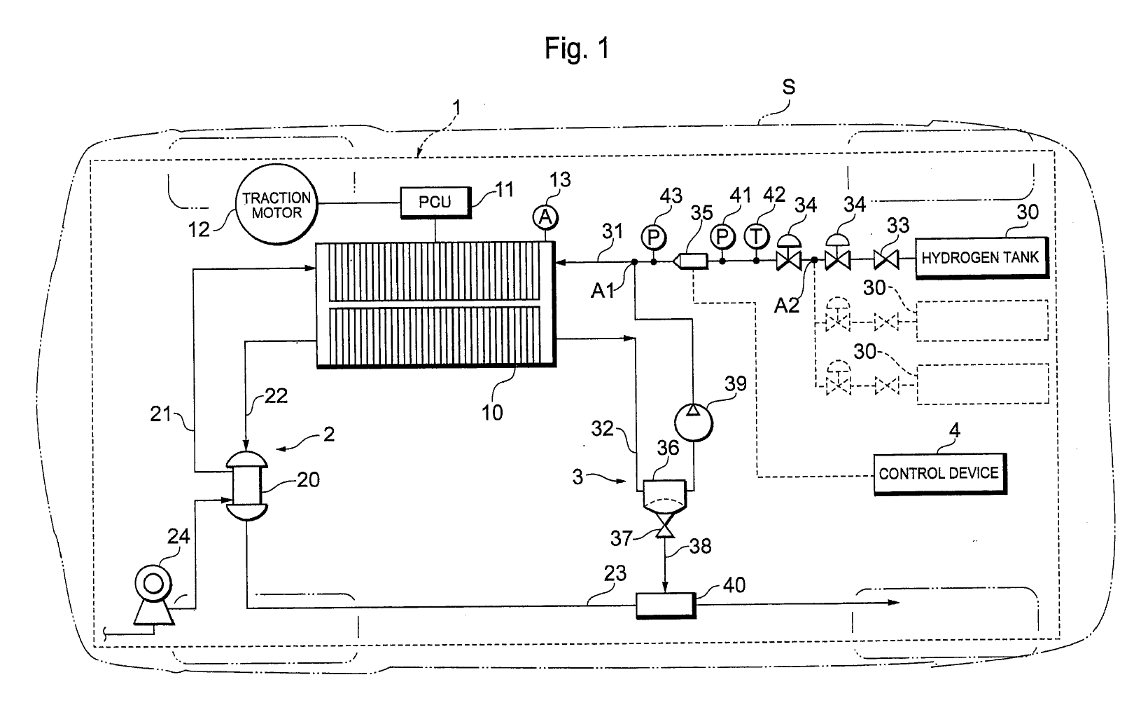

First, a constitution of the fuel cell system 1 according to the embodiment of the present invention will be described with reference to FIGS. 1 to 5. As shown in FIG. 1, the fuel cell system 1 according to the present embodiment includes a fuel cell 10 which receives supply of a reactive gas (an oxidizing gas and a fuel gas) to generate a power, and further includes an oxidizing gas piping system 2 which supplies air as an oxidizing gas to the fuel cell 10, a hydrogen gas piping system 3 which supplies a hydrogen gas as a fuel gas to the fuel cell 10, a control device 4 which generally controls the whole system and the like.

The fuel cell 10 has a stack structure in which the required number of unitary cells for receiving supply of the reactive gas to generate the power are laminated. The power generated by the fuel cell 10 is supplied to a power control unit (PCU) 11. The PCU 11 includes an inverter, a DC-DC converter and the like arranged between the fuel cell 10 and a traction motor 12. Moreover, a current sensor 13 which detects a current during power generation is attached to the fuel cell 10.

The oxidizing gas piping system 2 includes an air supply channel 21 which supplies, to the fuel cell 10, the oxidizing gas (air) humidified by a humidifier 20, an air discharge channel 22 which guides, to the humidifier 20, an oxidizing off gas coming from the fuel cell 10, and an exhaust channel 23 for guiding the oxidizing off gas from the humidifier 20 to the outside. The air supply channel 21 is provided with a compressor 24 which takes the oxidizing gas from atmospheric air to feed the gas under pressure to the humidifier 20.

The hydrogen gas piping system 3 includes a hydrogen tank 30 as a fuel supply source in which a high pressure hydrogen gas is received, a hydrogen supply channel 31 as a fuel supply channel for supplying the hydrogen gas of the hydrogen tank 30 to the fuel cell 10, and a circulation channel 32 for returning, to the hydrogen supply channel 31, a hydrogen off gas coming from the fuel cell 10. The hydrogen gas piping system 3 is one embodiment of a fuel supply system in the present invention. It is to be noted that instead of the hydrogen tank 30, a reforming unit which forms a hydrogen rich reforming gas from a hydrocarbon-based fuel, and a high pressure gas tank which brings the reforming gas formed by this reforming unit into a high pressure state to accumulate a pressure may be employed as the fuel supply sources. Alternatively, a tank having a hydrogen occluded alloy may be employed as the fuel supply source.

The hydrogen supply channel 31 is provided with a shutoff valve 33 which blocks or allows the supply of the hydrogen gas from the hydrogen tank 30, regulators 34 which adjust a pressure of the hydrogen gas, and an injector 35. Moreover, on an upstream side of the injector 35, a primary pressure sensor 41 and a temperature sensor 42 which detect a pressure and a temperature of the hydrogen gas in the hydrogen supply channel 31, respectively, are provided. On a downstream side of the injector 35 and an upstream side of a joining part between the hydrogen supply channel 31 and the circulation channel 32, a secondary pressure sensor 43 which detects the pressure of the hydrogen gas in the hydrogen supply channel 31 is provided.

The regulator 34 is a device which adjusts an upstream pressure (a primary pressure) into a preset secondary pressure. In the present embodiment, a mechanical type pressure reducing valve which reduces the primary pressure is employed as the regulator 34. A publicly known construction may be adopted for the mechanical type pressure reducing valve, having a housing formed with a back pressure chamber and a pressure adjustment chamber separated by a diaphragm for reducing the primary pressure in the pressure adjustment chamber by a predetermined pressure to the secondary pressure by means of the back pressure inside the back pressure chamber. In the present embodiment, as shown in FIG. 1, two regulators 34 can be arranged on the upstream side of the injector 35 to effectively reduce an upstream pressure of the injector 35. Therefore, a degree of freedom in designing a mechanical structure (a valve body, a housing, a channel, a driving device, etc.) of the injector 35 can be raised. The upstream pressure of the injector 35 can be reduced, so that it can be prevented that the valve body of the injector 35 does not easily move owing to increase of a difference between the upstream pressure and a downstream pressure of the injector 35. Therefore, a variable pressure adjustment region of the downstream pressure of the injector 35 can be broadened, and lowering of a response property of the injector 35 can be suppressed.

The injector 35 is an electromagnetic driving type opening/closing valve capable of directly driving the valve body with an electromagnetic driving power in a predetermined drive cycle to detach the valve body from a valve seat, whereby a gas flow rate and a gas pressure can be adjusted. The injector 35 includes the valve seat having an injection hole for injecting a gas fuel such as the hydrogen gas, a nozzle body which supplies and guides the gas fuel to the injection hole, and the valve body which is movably held in an axial direction (a gas flow direction) with respect to this nozzle body to open and close the injection hole. In the present embodiment, the valve body of the injector 35 is driven by a solenoid as an electromagnetic driving device, and a pulse-like exciting current to be supplied to this solenoid can be turned on or off to switch opening areas of the injection hole in two stages or multiple stages. A gas injection time and a gas injection timing of the injector 35 are controlled based on a control signal output from the control device 4, whereby a flow rate and a pressure of the hydrogen gas are precisely controlled. The injector 35 directly drives the valve (the valve body and the valve seat) with the electromagnetic driving power to open and close the valve, and a drive cycle of the injector can be controlled up to a region of high response. Therefore, the injector has a high response property.

To supply a required gas flow rate to the downstream side of the injector 35, at least one of an opening area (an open degree) and an opening time of the valve body provided in a gas channel of the injector 35 is changed, whereby the flow rate (or a hydrogen molar concentration) of the gas to be supplied to the downstream side (a fuel cell 10 side) is adjusted. It is to be noted that the valve body of the injector 35 is opened and closed to adjust the gas flow rate, and a pressure of the gas to be supplied to the downstream side of the injector 35 is reduced as compared with that of the gas to be supplied to the upstream side of the injector 35. Therefore, the injector 35 can be interpreted as a pressure adjustment valve (a pressure reducing valve, a regulator). Moreover, in the present embodiment, the injector 35 can be interpreted as a variable pressure adjustment valve capable of changing a pressure adjustment amount (a pressure reduction amount) of the upstream gas pressure of the injector 35 so as to match a required pressure in a predetermined pressure region based on gas requirement.

It is to be noted that in the present embodiment, as shown in FIG. 1, the injector 35 is disposed on the upstream side from a joining part A1 between the hydrogen supply channel 31 and the circulation channel 32. In a case where a plurality of hydrogen tanks 30 are employed as fuel supply sources as shown by broken lines in FIG. 1, the injector 35 is disposed on the downstream side from a part (a hydrogen gas joining part A2) where the hydrogen gas supplied from the hydrogen tanks 30 is joined.

The circulation channel 32 is connected to a discharge channel 38 via a gas-liquid separator 36 and an exhaust discharge valve 37. The gas-liquid separator 36 collects a water content from the hydrogen off gas. The exhaust discharge valve 37 operates based on a command from the control device 4 to discharge (purge) the water content collected by the gas-liquid separator 36 and the hydrogen off gas (a fuel off gas) including impurities from the circulation channel 32. The circulation channel 32 is also provided with a hydrogen pump 39 which pressurizes the hydrogen off gas in the circulation channel 32 to feed the gas toward the hydrogen supply channel 31. It is to be noted that the hydrogen off gas discharged via the exhaust discharge valve 37 and the discharge channel 38 is diluted by a dilution unit 40 to join the oxidizing off gas in the exhaust channel 23. The circulation channel 32 is one embodiment of a fuel discharge channel in the present invention, and the exhaust discharge valve 37 is one embodiment of a discharge valve in the present invention.

The control device 4 detects an operation amount of an operation member (an accelerator or the like) for acceleration provided on the fuel cell vehicle S, and receives control information such as an acceleration required value (e.g., a required power generation amount from a load device such as the traction motor 12) to control operations of various devices in the system. It is to be noted that in addition to the traction motor 12, the load device includes a generic power consumption device such as an auxiliary machine (e.g., a motor of the compressor 24, the hydrogen pump 39 or a cooling pump) required for operating the fuel cell 10, an actuator for use in any device (a change gear, a wheel control device, a steering device, a suspension device or the like) concerned with running of the fuel cell vehicle S, an air conditioning device (an air conditioner) of a passenger space, a light or an audio system.

The control device 4 is constituted of a computer system (not shown). Such a computer system includes a CPU, a ROM, a RAM, a HDD, an input/output interface, a display and the like. The CPU reads and executes any control program recorded in the ROM to realize any control operation.

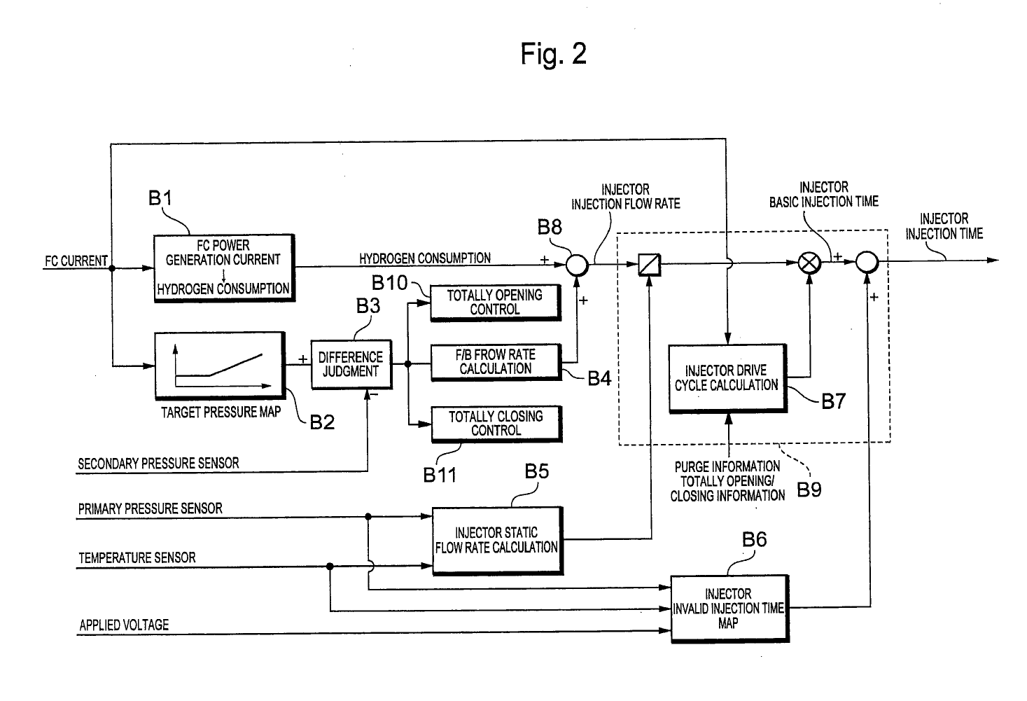

Specifically, as shown in FIG. 2, the control device 4 calculates a flow rate (hereinafter referred to as the “hydrogen consumption”) of the hydrogen gas to be consumed by the fuel cell 10 based on an operation state (a current value during power generation of the fuel cell 10 detected by the current sensor 13) of the fuel cell 10 (a fuel consumption calculating function: B1). In the present embodiment, the hydrogen consumption is calculated and updated for each calculation period of the control device 4 by use of a specific calculating equation indicating a relation between the power generation current value and the hydrogen consumption of the fuel cell 10.

Moreover, the control device 4 calculates a target pressure value of the hydrogen gas to be supplied to the fuel cell 10 in a downstream position of the injector 35 based on the operation state (the power generation current value during the power generation of the fuel cell 10 detected by the current sensor 13) of the fuel cell 10 (a target pressure value calculating function: B2). In the present embodiment, the target pressure value is calculated and updated for each calculation period of the control device 4 by use of a specific map indicating a relation between the power generation current value and the target pressure value of the fuel cell 10.

Furthermore, the control device 4 calculates a difference between the calculated target pressure value and a pressure value (a detected pressure value) detected by the secondary pressure sensor 43 in the downstream position of the injector 35, and judges whether or not an absolute value of this difference is a predetermined threshold value or less (a difference judgment function: B3). Then, in a case where the absolute value of the difference is the predetermined threshold value or less, the control device 4 calculates a feedback correction flow rate for reducing this difference (a feedback correction flow rate calculating function: B4). The feedback correction flow rate is a hydrogen gas flow rate to be added to the hydrogen consumption in order to reduce the absolute value of the difference between the target pressure value and the detected pressure value. In the present embodiment, the feedback correction flow rate is calculated by use of a target following type control rule of PI control or the like.

In addition, the control device 4 controls an upstream static flow rate of the injector 35 based on an upstream gas state of the injector 35 (a pressure of the hydrogen gas detected by the primary pressure sensor 41 and the temperature of the hydrogen gas detected by the temperature sensor 42) (a static flow rate calculating function: B5). In the present embodiment, the static flow rate is calculated and updated for each calculation period of the control device 4 by use of a specific calculating equation indicating a relation between the pressure and temperature of the hydrogen gas on the upstream side of the injector 35 and the static flow rate.

Moreover, the control device 4 calculates an invalid injection time of the injector 35 based on an upstream gas state of the injector 35 (the pressure and temperature of the hydrogen gas) and an applied voltage (an invalid injection time calculating function: B6). Here, the invalid injection time is a time required from a time when the injector 35 receives the control signal from the control device 4 to a time when injecting is actually started. In the present embodiment, the invalid injection time is calculated and updated for each calculation period of the control device 4 by use of a specific map indicating a relation among the pressure and temperature of the hydrogen gas on the upstream side of the injector 35, the applied voltage and the invalid injection time.

Furthermore, the control device 4 calculates a drive cycle and a drive frequency of the injector 35 in accordance with an operation state of the fuel cell 10 (the current value during the power generation of the fuel cell 10 detected by the current sensor 13) (a drive cycle calculating function: B7). Here, the drive cycle is the cycle of opening/closing driving of the injector 35, that is, a period of a stepped (on/off) waveform indicating opening/closing states of the injection hole. The drive frequency is an inverse number of the drive cycle.

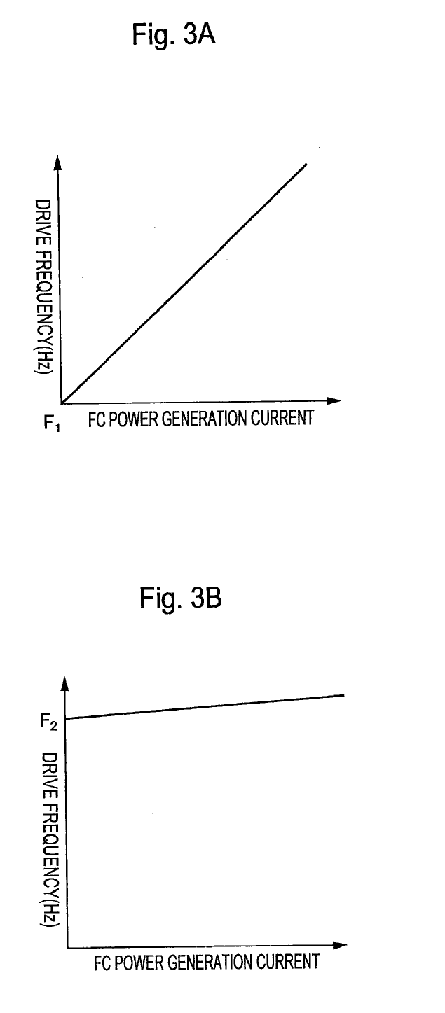

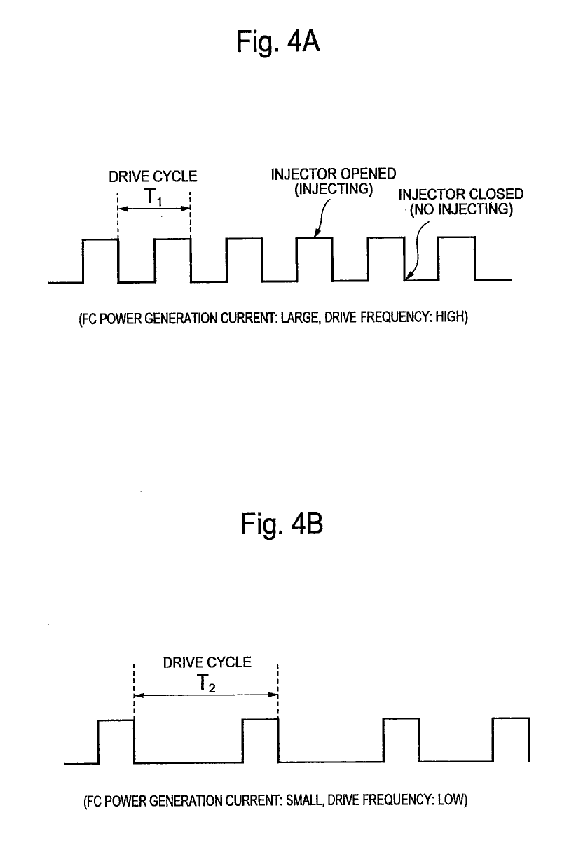

The control device 4 of the present embodiment calculates the drive frequency by use of a map indicating the power generation current value and the drive frequency of the fuel cell 10 as shown in FIG. 3A, so that the drive frequency lowers (the drive cycle lengthens), as the power generation current value of the fuel cell 10 decreases. The control device also calculates the drive cycle corresponding to this drive frequency. For example, when the power generation current value of the fuel cell 10 is large, a high drive frequency (a short drive cycle T₁) is set as shown in FIG. 4A. On the other hand, when the power generation current value of the fuel cell 10 is small, a low drive frequency (a long drive cycle T₂) is set as shown in FIG. 4B.

Moreover, the control device 4 of the present embodiment controls an opening/closing operation of the exhaust discharge valve 37 to execute a purge operation (an operation to discharge the hydrogen off gas from the circulation channel 32 via the exhaust discharge valve 37). Then, during execution of such a purge operation, the control device 4 sets the drive frequency of the injector 35 to a higher frequency (a short drive cycle) than during the execution of no purge operation by use of a map shown in FIG. 3B. Specifically, as shown in FIG. 3B, the control device 4 sets a minimum drive frequency F₂ during the execution of the purge operation to be remarkably higher than a minimum drive frequency F₁ at a usual time (during the execution of no purge operation). The control device 4 sets the drive cycle to a multiple number of the calculation period.

Furthermore, the control device 4 adds up the hydrogen consumption and the feedback correction flow rate to calculate an injection flow rate of the injector 35 (an injection flow rate calculating function: B8). Then, the control device 4 multiplies the drive cycle by a value obtained by dividing the injection flow rate of the injector 35 by the static flow rate to calculate a basic injection time of the injector 35, and the device adds up this basic injection time and the invalid injection time to calculate a total injection time of the injector 35 (a total injection time calculating function: B9).

Then, the control device 4 outputs a control signal for realizing the total injection time of the injector 35 calculated through the above-mentioned procedure, and controls the gas injection time and the gas injection timing of the injector 35 to adjust the flow rate and pressure of the hydrogen gas supplied to the fuel cell 10. That is, when the absolute value of the difference is the predetermined threshold value or less, the control device 4 realizes feedback control for reducing this difference.

Moreover, when the absolute value of the difference between the target pressure value and the detected pressure value exceeds the predetermined threshold value, the control device 4 realizes totally opening control or totally closing control of the injector 35. Here, the totally opening or closing control is so-called open loop control to maintain an open degree of the injector 35 to a totally opened or closed degree until the absolute value of the difference between the target pressure value and the detected pressure value becomes the predetermined threshold value or less.

Specifically, when the absolute value of the difference exceeds the predetermined threshold value and the detected pressure value is smaller than the target pressure value, the control device 4 outputs a control signal for totally opening the injector 35 (i.e., for continuously injecting) to maximize the flow rate and pressure of the hydrogen gas to be supplied to the fuel cell 10 (a totally opening control function: B10). On the other hand, when the absolute value of the difference exceeds the predetermined threshold value and the detected pressure value is larger than the target pressure value, the control device 4 outputs a control signal for totally closing the injector 35 (i.e., for stopping the injecting) to minimize the flow rate and pressure of the hydrogen gas to be supplied to the fuel cell 10 (a totally closing control function: B11).

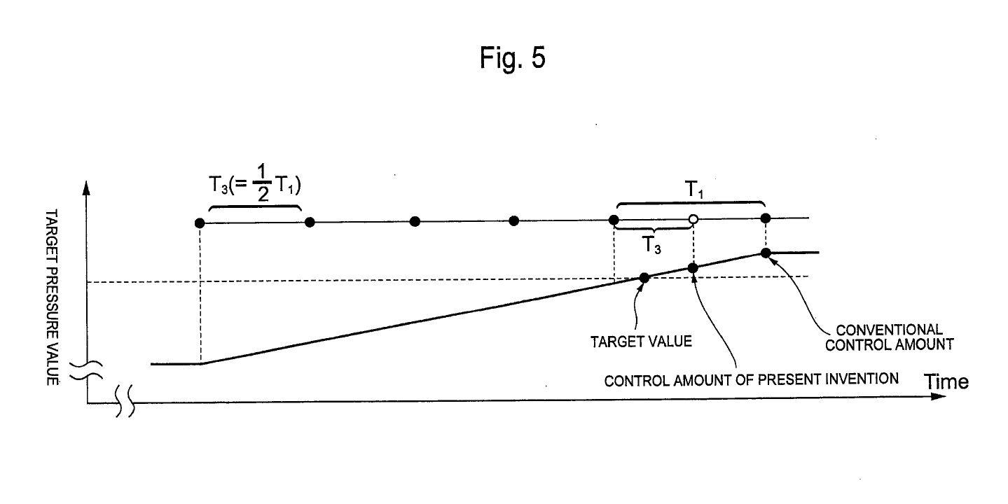

Moreover, the control device 4 sets a high drive frequency (a short drive cycle) during the totally opening control or the totally closing control of the injector 35. In the present embodiment, the drive frequency in a case where the totally opening control or the totally closing control is performed is set to be twice the drive frequency in a case where the feedback control is performed. That is, when the shortest drive cycle for performing the feedback control is T₁ shown in FIG. 5, the shortest drive cycle for performing the totally opening control or the totally closing control is set to T₃ (=0.5T₁) shown in FIG. 5. The high drive frequency (the short drive cycle) is set during the totally opening control or the totally closing control of the injector 35 in this manner, whereby overshoot (a state in which the detected pressure value as a control amount is above the target pressure value) during the totally opening control or undershoot (a state in which the detected pressure value is below the target pressure value) during the totally closing control can be suppressed.

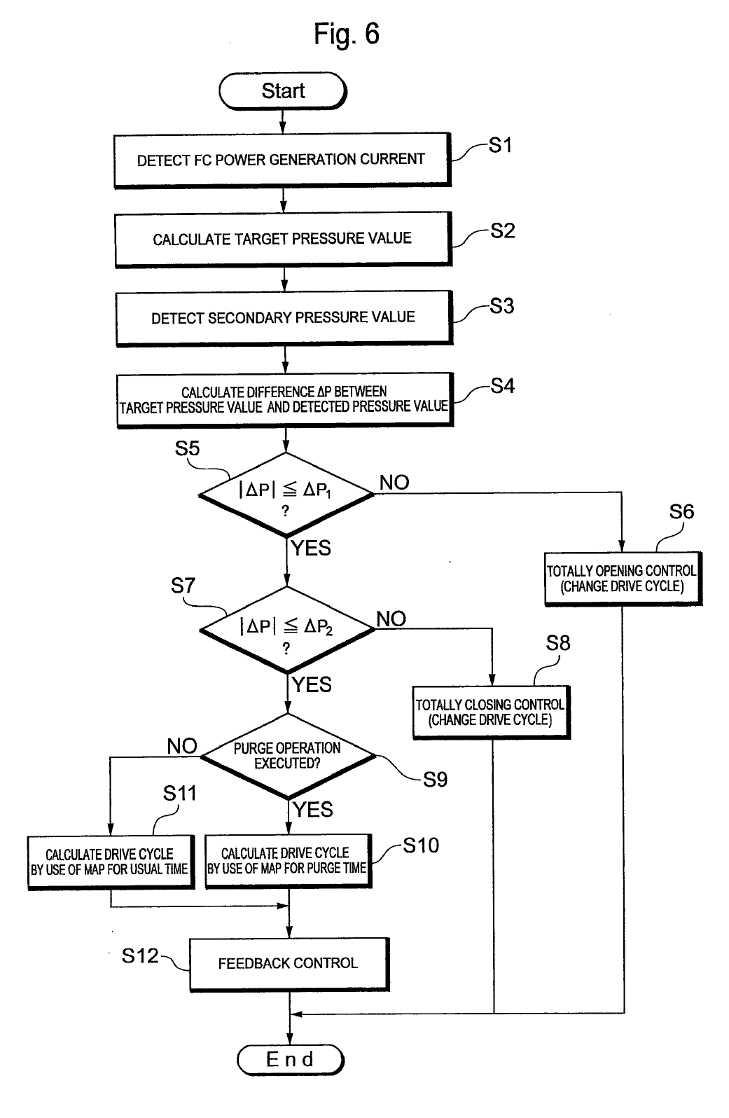

Next, an operation method of the fuel cell system 1 according to the present embodiment will be described with reference to a flow chart of FIG. 6.

During a usual operation of the fuel cell system 1, the hydrogen gas is supplied from the hydrogen tank 30 to a fuel pole of the fuel cell 10 via the hydrogen supply channel 31, and humidified and adjusted air is supplied to an oxidation pole of the fuel cell 10 via the air supply channel 21 to generate a power. In this case, the power (a required power) to be extracted from the fuel cell 10 is calculated by the control device 4, and an amount of hydrogen gas and air corresponding to an amount of the power to be generated is supplied into the fuel cell 10. In the present embodiment, it is prevented that irregular operation sound is generated in a case where an operation state changes from such a usual operation (e.g., in a case where the amount of the power to be generated lowers).

That is, first, the control device 4 of the fuel cell system 1 detects the current value during the power generation of the fuel cell 10 by use of the current sensor 13 (a current detection step: S1). The control device 4 calculates the target pressure value of the hydrogen gas to be supplied to the fuel cell 10 based on the current value detected by the current sensor 13 (a target pressure value calculation step: S2). Then, the control device 4 detects the downstream pressure value of the injector 35 by use of the secondary pressure sensor 43 (a pressure value detection step: S3). Then, the control device 4 calculates a difference ΔP between the target pressure value calculated in the target pressure value calculation step S2 and the pressure value (the detected pressure value) detected in the pressure value detection step S3 (a difference calculation step: S4).

Next, the control device 4 judges whether or not an absolute value of the difference ΔP calculated in the difference calculation step S4 is a first threshold value ΔP₁ or less (a first difference judgment step: S5). The first threshold value ΔP₁ is a threshold value for switching the feedback control and the totally opening control in a case where the detected pressure value is smaller than the target pressure value. In a case where it is judged that the absolute value of the difference ΔP between the target pressure value and the detected pressure value is the first threshold value ΔP₁ or less, the control device 4 shifts to a second difference judgment step S7 described later. On the other hand, in a case where it is judged that the absolute value of the difference ΔP between the target pressure value and the detected pressure value exceeds the first threshold value ΔP₁, the control device 4 outputs a control signal for totally opening the injector 35 (for continuously injecting) to maximize the flow rate and pressure of the hydrogen gas to be supplied to the fuel cell 10 (a totally opening control step: S6). In such a totally opening control step S6, the control device 4 sets a high drive frequency (a short drive cycle).

In a case where it is judged in the first difference judgment step S5 that the absolute value of the difference ΔP between the target pressure value and the detected pressure value is a first threshold value ΔP₁ or less, the control device 4 judges whether or not the absolute value of the difference ΔP calculated in the difference calculation step S4 is the second threshold value ΔP₂ or less (the second difference judgment step: S7). The second threshold value ΔP₂ is a threshold value for switching the feedback control and the totally closing control in a case where the detected pressure value is larger than the target pressure value. In a case where it is judged that the absolute value of the difference ΔP between the target pressure value and the detected pressure value is the second threshold value ΔP₂ or less, the control device 4 shifts to a purge judgment step S9 described later. On the other hand, in a case where it is judged that the absolute value of the difference ΔP between the target pressure value and the detected pressure value exceeds the second threshold value ΔP₂, the control device 4 outputs a control signal for totally closing the injector 35 (for stopping the injecting) to minimize the flow rate and pressure of the hydrogen gas to be supplied to the fuel cell 10 (a totally closing control step: S8). In such a totally closing control step S8, the control device 4 sets a high drive frequency (a short drive cycle).

In a case where it is judged in the second difference judgment step S7 that the absolute value of the difference ΔP between the target pressure value and the detected pressure value is the second threshold value ΔP₂ or less, the control device 4 judges whether or not the purge operation is being executed (the purge judgment step: S9). Then, in a case where it is judged that the purge operation is being executed, the control device 4 calculates the drive frequency and drive cycle of the injector 35 based on the map for executing the purge operation shown in FIG. 3B and the power generation current value of the fuel cell 10 detected in the current detection step S1 (a purge time drive cycle calculation step: S10). On the other hand, in a case where it is judged that the purge operation is not executed, the control device 4 calculates the drive frequency and drive cycle of the injector 35 based on the map for the usual time shown in FIG. 3A and the power generation current value of the fuel cell 10 detected in the current detection step S1 (a usual time drive cycle calculation step: S11). Afterward, the control device 4 realizes the feedback control by use of the calculated drive cycle (a feedback control step: S12).

The feedback control step S12 will specifically be described. First the control device 4 calculates the flow rate of the hydrogen gas to be consumed by the fuel cell 10 (the hydrogen consumption) based on the current value detected by the current sensor 13. Moreover, the control device 4 calculates the feedback correction flow rate based on the difference ΔP between the target pressure value calculated in the target pressure value calculation step S2 and the detected downstream pressure value of the injector 35 detected in the pressure value detection step S3. Then, the control device 4 adds up the calculated hydrogen consumption and the feedback correction flow rate to calculate the injection flow rate of the injector 35.

Moreover, the control device 4 calculates an upstream static flow rate of the injector 35 based on the upstream pressure of the hydrogen gas of the injector 35 detected by the primary pressure sensor 41 and the temperature of the hydrogen gas on the upstream side of the injector 35 detected by the temperature sensor 42. Then, the control device 4 multiplies the drive cycle by the value obtained by dividing the injection flow rate of the injector 35 by the static flow rate to calculate the basic injection time of the injector 35.

Furthermore, the control device 4 calculates the invalid injection time of the injector 35 based on the upstream hydrogen gas pressure of the injector 35 detected by the primary pressure sensor 41, the upstream hydrogen gas temperature of the injector 35 detected by the temperature sensor 42 and the applied voltage. Then, the control device 4 adds up this invalid injection time and the basic injection time of the injector 35 to calculate the total injection time of the injector 35. Afterward, the control device 4 outputs the control signal concerning the calculated total injection time of the injector 35 to control the gas injection time and gas injection timing of the injector 35, whereby the flow rate and pressure of the hydrogen gas to be supplied to the fuel cell 10 are adjusted.

According to the fuel cell system 1 of the embodiment described above, when the power generation current value of the fuel cell 10 is small, the low drive frequency (the long drive cycle) can be set. Therefore, the irregular operation of the injector 35 during the lowering of the amount of the power to be generated by the fuel cell 10 is inhibited, whereby the generation of undesirable operation sound can be suppressed.

Moreover, according to the fuel cell system 1 of the embodiment described above, when the opening/closing operation of the exhaust discharge valve 37 is controlled to execute the purge operation, the high drive frequency (the short drive cycle) can be set. Therefore, the supply pressure of the hydrogen gas during the execution of the purge operation can be inhibited from temporarily lowering. As a result, lowering of a power generation performance during the purge can be inhibited.

Furthermore, in the fuel cell system 1 according to the embodiment described above, the high drive frequency (the short drive cycle) can be set during the totally opening control or the totally closing control of the injector 35. Therefore, the overshoot during the totally opening control of the injector 35 and the undershoot during the totally closing control of the injector 35 can be suppressed, and a control precision during the totally opening or closing control of the injector 35 can be improved.

In addition, according to the fuel cell system 1 of the above-mentioned embodiment, the drive cycle is set to the multiple number of the calculation period of the control device 4, so that the drive cycle of the injector 35 can be synchronized with the calculation period of the control device 4. As a result, the control precision of the injector 35 can be improved.

Moreover, the fuel cell vehicle S (a mobile article) according to the above-mentioned embodiment includes the fuel cell system 1 capable of inhibiting the irregular operation of the injector 35 to suppress the generation of the undesirable operation sound, so that discomfort is scarcely given to a passenger. The operation sound is stabilized, whereby the passenger can be provided with feeling of security.

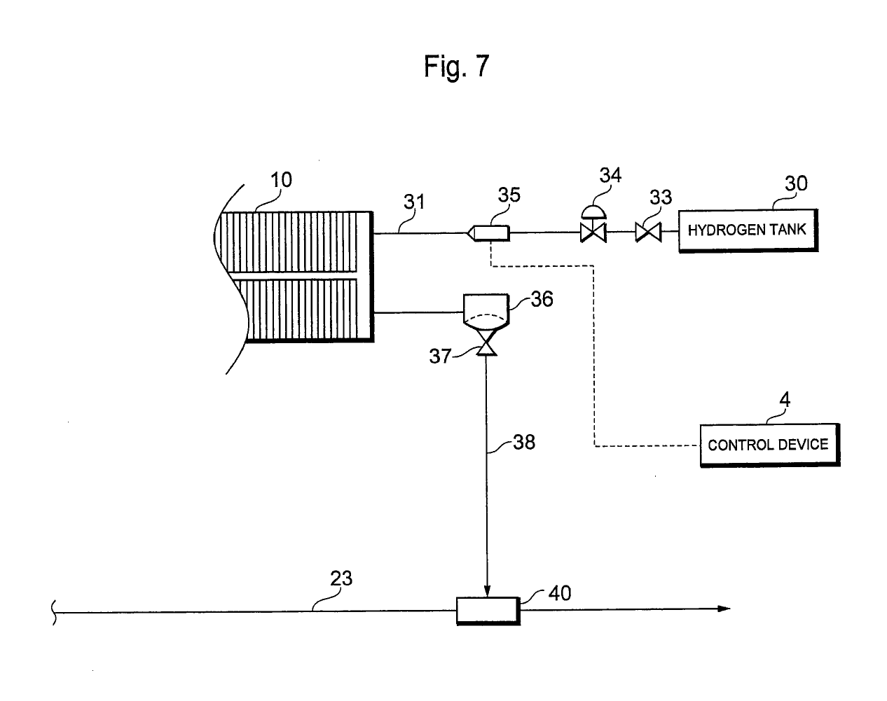

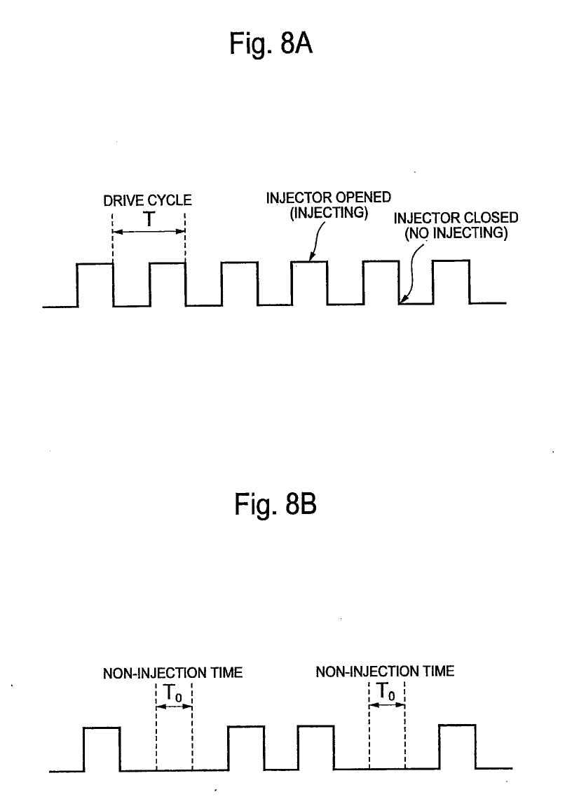

It is to be noted that in the above embodiment, an example in which the hydrogen gas piping system 3 of the fuel cell system 1 is provided with the circulation channel 32 has been described. However, for example, as shown in FIG. 7, a discharge channel 38 may directly be connected to a fuel cell 10 to omit a circulation channel 32. Even in a case where such a constitution (a dead end system) is employed, a control device 4 appropriately sets a drive frequency (a drive cycle) of an injector 35 in accordance with an operation state in the same manner as in the above embodiment, whereby function and effect similar to those of the above embodiment can be obtained.

Moreover, in the above embodiment, an example in which the circulation channel 32 is provided with the hydrogen pump 39 has been described. However, an ejector may be employed instead of the hydrogen pump 39. In the above embodiment, an example has been described in which the exhaust discharge valve 37 to realize both gas exhaust and water discharge is provided in the circulation channel 32. However, a discharge valve to discharge the water content collected by a gas-liquid separator 36 to the outside and an exhaust valve to discharge a gas from the circulation channel 32 may separately be provided, whereby the control device 4 can control the exhaust valve.

Furthermore, in the above embodiment, an example has been described in which the secondary pressure sensor 43 is disposed in the downstream position of the injector 35 of the hydrogen supply channel 31 of the hydrogen gas piping system 3 to set the operation state (the injection time) of the injector 35 so that the pressure in this position is adjusted (brought close to the predetermined target pressure value). However, the position of the secondary pressure sensor is not limited to this example.

For example, the secondary pressure sensor may be disposed in a position close to a hydrogen gas inlet of the fuel cell 10 (on the hydrogen supply channel 31), a position close to a hydrogen gas outlet of the fuel cell 10 (on the circulation channel 32) or a position close to the outlet of the hydrogen pump 39 (on the circulation channel 32). In such a case, a map in which the target pressure value in each position of the secondary pressure sensor is recorded is beforehand prepared, and the feedback correction flow rate is calculated based on the target pressure value recorded in this map and the pressure value (the detected pressure value) detected by the secondary pressure sensor.

Moreover, in the above embodiment, an example has been described in which the hydrogen supply channel 31 is provided with the shutoff valve 33 and the regulators 34. However, the injector 35 performs a function of a variable pressure adjustment valve and a function of a shutoff valve to block supply of the hydrogen gas. Therefore, the shutoff valve 33 and the regulators 34 do not have to be provided. In consequence, when the injector 35 is employed, the shutoff valve 33 and the regulators 34 can be omitted, so that the system can be miniaturized and inexpensively constituted.

Furthermore, in the above embodiment, an example has been described in which the drive frequency (the drive cycle) of the injector 35 is set based on the current value of the fuel cell 10 during the power generation. However, the drive frequency (the drive cycle) of the injector 35 may be set based on the target pressure value and the detected pressure value of the hydrogen gas. In this case, the drive frequency is calculated using the map indicating the relation between the target pressure value (or the detected pressure value) and the drive frequency so that the drive frequency lowers (the drive cycle lengthens), as the target pressure value (or the detected pressure value) decreases, whereby the drive cycle corresponding to this drive frequency can be calculated. Thus, the irregular operation of the injector during the lowering of the supply pressure of the hydrogen gas can be inhibited to suppress the generation of the undesirable operation sound.

Moreover, in the above embodiment, an example has been described in which the current value during the power generation of the fuel cell 10 is detected to set the drive frequency (the drive cycle) of the injector 35 based on this current value. However, another physical amount (a voltage value or a power value during the power generation of the fuel cell 10, a temperature of the fuel cell 10 or the like) indicating the operation state of the fuel cell 10 may be detected to set the drive frequency (the drive cycle) of the injector 35 in accordance with this detected physical amount. Moreover, the control device may judge the operation state such as whether or not the fuel cell 10 is in a stopped state, an operated state during start, an operated state immediately before entering an intermittent operation, an operated state immediately after recovering from the intermittent operation, or a usually operated state, to set the drive frequency (the drive cycle) of the injector 35 in accordance with such an operation state.

### INDUSTRIAL APPLICABILITY

As described in the above embodiment, a fuel cell system according to the present invention may be mounted on not only a fuel cell vehicle but also any type mobile article other than the fuel cell vehicle (a robot, a ship, an airplane or the like). The fuel cell system of the present invention may be applied to a stationary power generation system for use as a power generation equipment for a construction (a housing, a building or the like).

1. (canceled)

2. A fuel cell system comprising: a fuel cell; a fuel supply system to supply a fuel gas to this fuel cell; an injector which adjusts a gas state on an upstream side of this fuel supply system to supply the gas to a downstream side; and a control device for driving and controlling this injector in a predetermined drive cycle,
wherein the control device sets the drive cycle to be long when an amount of a power generated by the fuel cell is small.

3. (canceled)

4. (canceled)

5. (canceled)

6. (canceled)

7. A mobile article which comprises the fuel cell system according to claim 2.

8. The fuel cell system according to claim 2, wherein the control device sets the drive cycle so as to inhibit an irregular operation of the injector.
